(19) United States
(12) Patent Application Publication
(10) Pub. No.: US 2011/0045959 A1
(43) Pub. Date: Feb. 24, 2011

(54) CELL PROCESSING DEVICE

(75) Inventors: Kyohei KURIHARA, Tokyo (JP); Douglas M. ARM, Carlsbad, CA (US); Robert K. SHANAHAN, Carlsbad, CA (US); Lucas V. FORNACE, La Jolla, CA (US)

Correspondence Address: SCULLY SCOTT MURPHY & PRESSER, PC, 400 GARDEN CITY PLAZA, SUITE 300, GARDEN CITY, NY, 11530, US

(73) Assignees: OLYMPUS CORPORATION, Tokyo (JP); CYTORI THERAPEUTICS, INC., San Diego, CA (US)

(21) Appl. No.: 12/854,266

(22) Filed: Aug. 11, 2010

Related U.S. Application Data
(63) Continuation of application No. PCT/JP2009/052127, filed on Feb. 9, 2009.

(30) Foreign Application Priority Data
Feb. 13, 2008 (JP) 2008-032451

(51) Int. Cl. B04B 15/00

(52) U.S. Cl. 494/10

(57) ABSTRACT

The count of cells that are to be concentrated in a centrifugal container and transplanted can be measured without damaging these cells. Disclosed is a cell processing device comprising: a centrifugal separator which concentrates cells by rotating a centrifugal container that contains a cell suspension yielded by digestion of a biological tissue; a property detection unit which detects a property of the cell suspension contained in the centrifugal container of the centrifugal separator; and a cell count enumeration unit which calculates the cell count on the basis of the property of the cell suspension detected by the property detection unit.

### CROSS-REFERENCE TO RELATED APPLICATIONS

This application is based on Japanese Patent Application No. 2008-032451, the content of which is incorporated herein by reference.

### BACKGROUND OF THE INVENTION

1. Field of the Invention

The present invention relates to a cell processing device.

2. Description of Related Art

Heretofore, there is a known cell processing device which digests a biological tissue such as an adipose tissue by agitation with a digestive enzyme liquid, and which collects adipose-derived cells by concentrating the thus yielded cell suspension with a centrifugal separator (for example, PCT International Publication No. WO2005/012480).

In order to check whether or not the extracted adipose-derived cells, serving as the final product, have reached a desired cell count, it is necessary in this cell processing device to take out a part of the cell suspension as a sample and to measure the cell count thereof by using a microscope or the like.

However, because it is necessary and indispensable in the cell processing device of PCT International Publication No. WO2005/012480 to take out a part of the cell suspension as a sample, contaminations with dust, bacteria, or such matters are more likely to occur if a syringe needle has to be inserted in the cell suspension to take out the sample from the centrifugal container. The cell suspension taken out as the sample is to be directly discarded, which is a waste of precious cells.

### BRIEF DESCRIPTION OF THE INVENTION

An object of the present invention is to provide a cell processing device which can measure the count of cells that are to be concentrated in a centrifugal container and transplanted, without damaging these cells.

One aspect of the present invention is to provide a cell processing device comprising: a centrifugal separator which concentrates cells by rotating a centrifugal container that contains a cell suspension yielded by digestion of a biological tissue; a property detection unit which detects a property of the cell suspension contained in the centrifugal container of the centrifugal separator; and a cell count enumeration unit which calculates the cell count on the basis of the property of the cell suspension detected by the property detection unit.

According to the above-mentioned aspect, the cell suspension yielded by digestion of the biological tissue is contained in the centrifugal container, and concentrated by the operation of the centrifugal separator. The concentrated cells in the centrifugal container are to be taken out from the centrifugal container and transplanted into an organism body: however, before doing so, the property of the cell suspension is detected by the operation of the property detection unit in a state where these cells are being contained in a form of cell suspension within the centrifugal container. The property of the cell suspension can be exemplified by an electrical conduction property or an optical property. Then, on the basis of the detected property, the cell count is calculated by the cell count enumeration unit. That is to say, the count of concentrated cells can be obtained without damaging these cells in a state where these cells are being contained as the cell suspension in the centrifugal container.

In the above-mentioned aspect, the property detection unit may be a pair of electrodes which are oppositely arranged in the centrifugal container for detecting an electrical conduction property of the cell suspension held therebetween.

The electrical conduction property of the cell suspension can be readily detected by applying a voltage between the pair of electrodes and measuring the electric current running therebetween. The electrical conduction property is determined by an electrical conduction property of a constituent liquid of the cell suspension and an electrical conduction property of cells therein. Therefore, when the amount of the cell suspension having a liquid of a known electrical conduction property is fixed, the relation between the cell count and the electrical conduction property can be set uniquely. Accordingly, by setting the relation between the cell count and the electrical conduction property in advance, the cell count in the concentrated the cell suspension can be quickly and accurately detected only by detecting the electrical conduction property.

In the above-mentioned aspect, the centrifugal container may also be provided with a double-walled tube which supplies the cell suspension into the centrifugal container and discharges a supernatant therefrom upon the completion of centrifugal separation, and the pair of electrodes may be provided on this tube.

By so doing, the cell suspension can be supplied into the centrifugal container through the double-walled tube arranged in the centrifugal container; the cell suspension can be concentrated by the operation of the centrifugal separator; and thereafter the supernatant can be discharged again through the tube; as a result of which, the concentrated cells can be left remained in the centrifugal container. At this time, by leaving a part of the supernatant remained in the centrifugal container, the concentrated cell suspension can be produced, and the count of cells in the cell suspension held between the electrodes provided on the tube can be detected.

In the above-mentioned aspect, the pair of electrodes may also be provided on an inner wall in a vicinity of the bottom of the centrifugal container.

By so doing, the pair of electrodes can be arranged in an immersed state within a small amount of the concentrate cell suspension, and the centrifugal separation can be more reliably performed without disturbing the flow of the cell suspension and cells during the operation of the centrifugal separation.

In the above-mentioned aspect, the property detection unit may also comprise a light emitter and a light receiver for transmitting light through the cell suspension contained in the centrifugal container so as to thereby detect an optical property of the cell suspension.

By so doing, light emitted from the light emitter is transmitted through the concentrated cell suspension inside the centrifugal container and then received by the light receiver.

The amount of transmission light received by the light receiver is changed depending on the turbidity, serving as the optical property of the cell suspension, and the turbidity is changed depending on the cell count. Therefore, the amount of the received transmission light and the cell count are set uniquely. Accordingly, by setting the relation between the cell count and the optical property in advance, the cell count in the concentrated cell suspension can be accurately and quickly detected only by detecting the amount of the transmission light.

In the above-mentioned aspect, the centrifugal container may be made of an optically transparent material, and the light emitter and the light receiver may be arranged outside the centrifugal container.

By so doing, light emitted from the light emitter is transmitted through the walls of the centrifugal container made of the optically transparent material and through the cell suspension inside the centrifugal container, and then received by the light receiver. This makes it possible to detect the property of the cell suspension in a non-contact manner.

In the above-mentioned aspect, the centrifugal separator may also comprise a container holder which detachably holds the centrifugal container, and the light emitter and the light receiver may be provided on the container holder.

By so doing, the cell suspension is concentrated by operating the centrifugal separator while holding the centrifugal container, which contains the cell suspension, on the container holder. When the centrifugal container is held on the container holder, the centrifugal container is arranged between the light emitter and the light receiver. Then, after the cell suspension has been concentrated, the optical property of the cell suspension can be detected by operating the light emitter and the light receiver, and the cell count can be calculated. In this case, the centrifugal container to be in contact with the cell suspension can be made disposable so that the property detection unit comprising the light emitter and the light receiver can be repeatedly reused.

In the above-mentioned aspect, the cell processing device may also comprise a detection unit transfer mechanism which moves the light emitter and the light receiver closer to or apart from the centrifugal container.

By so doing, the light emitter and the light receiver can be moved apart from the centrifugal container by the operation of the detection unit transfer mechanism; the centrifugal separator can be operated in a state where the light emitter and the light receiver have been withdrawn to a position that would not hinder the centrifugal treatment; and, upon the completion of the concentration treatment, the light emitter and the light receiver can be moved again closer to the centrifugal container by the operation of the detection unit transfer mechanism, so as to thereby arrange the cell suspension on the optical axis of the light emitter and the light receiver; as a result of which, the optical property of the cell suspension can be detected.

The present invention offers an effect in which the count of cells that are to be concentrated in a centrifugal container and transplanted can be measured without damaging these cells.

### BRIEF DESCRIPTION OF THE SEVERAL VIEWS OF THE DRAWINGS

FIG. 1 is an overall block diagram which shows a cell processing device according to a first embodiment of the present invention.

FIG. 2 is a longitudinal cross-section which shows a modified example of the centrifugal container for use in the cell processing device of FIG. 1.

FIG. 3A illustrates a process of a centrifugal treatment and a cell count measurement using the centrifugal container of FIG. 2, in which the cell suspension is supplied.

FIG. 3B illustrates a process of the centrifugal treatment and the cell count measurement using the centrifugal container of FIG. 2, in which the cell suspension is concentrated.

FIG. 3C illustrates a process of the centrifugal treatment and the cell count measurement using the centrifugal container of FIG. 2, in which the cell suspension is discharged.

FIG. 3D illustrates a process of the centrifugal treatment and the cell count measurement using the centrifugal container of FIG. 2, in which the cell count is measured.

FIG. 4 is a longitudinal cross-section which shows a modified example of the arrangement of electrodes in the cell processing device of FIG. 1.

FIG. 5 is an overall block diagram which shows a cell processing device according to a second embodiment of the present invention.

FIG. 6 is a longitudinal cross-section which shows a modified example of the cell processing device of FIG. 5.

FIG. 7 is a longitudinal cross-section which shows another modified example of the cell processing device of FIG. 5.

### DETAILED DESCRIPTION OF THE INVENTION

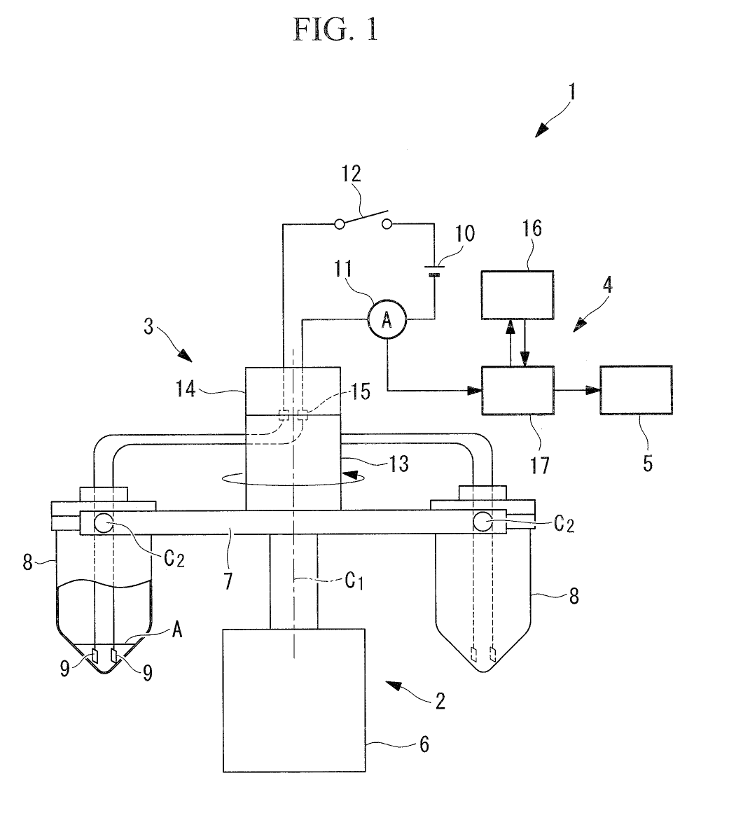

Hereunder is a description of a cell processing device 1 according to a first embodiment of the present invention, with reference to FIG. 1.

As shown in FIG. 1, the cell processing device 1 according to this embodiment comprises: a centrifugal separator 2 which concentrates a cell suspension A; a property detection unit 3 which detects an electrical conduction property of the cell suspension A that has been concentrated by the centrifugal separator 2; a cell count enumeration unit 4 which calculates the cell count on the basis of the property detected by the property detection unit 3; and a display unit 5 which displays the calculated cell count.

The centrifugal separator 2 comprises two centrifugal containers 8 attached to the both ends of an approximately horizontal arm 7 which is rotatable about a vertical shaft C₁ by a motor 6. The respective centrifugal containers 8 are attached to the arm 7 in a swingable manner about the shaft C₂. When the motor 6 is driven to rotate the arm 7, the bottoms of the centrifugal containers 8 are swung about the shaft C₂ toward the radially outward by the centrifugal force, and the cells inside the cell suspension A contained therein are collected due to their specific gravities toward the bottoms of the centrifugal containers 8.

The property detection unit 3 comprises: a pair of electrodes 9 which are inserted in a centrifugal container 8 and mutually oppositely arranged under the liquid surface of the cell suspension A contained therein; a constant voltage power source 10 which applies a fixed level of voltage between these electrodes 9; an ammeter 11 which detects the electric current running between the electrodes 9; and a switch 12 for opening and closing the circuit. By detecting the current value, the resistance value (electrical conduction property) of the cell suspension A can be indirectly detected from the relation between the detected current value and the applied voltage value. In the drawing, the reference sign 13 denotes a rotary part which is rotatable together with the arm 7, the reference sign 14 denotes a fixed part which is not rotatable, and the reference sign 15 denotes a brush-like relay provided between the rotary part 13 and the fixed part 14.

The cell count enumeration unit 4 comprises: a storage section 16 which stores the previously measured current value and cell count by associating them with each other; and a calculation section 17 which retrieves related data from the storage section 16, on the basis of the current value detected by the property detection unit 3, and calculates the associated cell count. The current value detected by the ammeter 11 is changed depending on the count of cells contained in the cell suspension A positioned between the pair of electrodes 9, provided that the type of the cells, the type of the liquid for suspending the cells, and the amount of the cell suspension A are already known. Therefore, by measuring the relation between the cell count and the current value in advance, the cell count can be accurately obtained from the current value.

The type of data to be stored in the storage section 16 may be a table including a combination of a plurality of sets of current values and cell counts, a function between the current value and the cell count, or a graph showing the relation between them. In the case of a table, if the detected current value is found to be an intermediate value between stored current values, an interpolation operation may be performed with use of stored current values to thereby calculate the cell count.

Hereunder is a description of the operation of the thus constructed cell processing device 1 according to this embodiment.

For example, a biological tissue such as an adipose tissue is agitated with a digestive fluid in a cell processing container (not shown), to thereby produce a cell suspension A in which adipose-derived cells are separated within the digestive fluid. The produced cell suspension A is then poured in the respective centrifugal containers 8.

Then, the arm 7 is rotated by the operation of the centrifugal separator 2 to effect the centrifugal separation of the cell suspension A contained in the centrifugal containers 8 so as to collect cells to the bottoms of the centrifugal containers 8. Thereafter, the supernatant is discharged, and a washing treatment, including adding a washing liquid, performing a centrifugal separation, and discharging the supernatant, is performed one or more times. By so doing, adipose-derived cells with a sufficiently reduced concentration of the digestive fluid can be obtained.

In the cell processing device 1 according to this embodiment, after the above-mentioned adipose-derived cells have been separated, the supernatant is discharged while leaving a part of it, and the separated adipose-derived cells are re-suspended in the remaining supernatant. By so doing, a predetermined amount of the concentrated cell suspension A is given.

In this state, the switch 12 is closed to thereby apply a fixed level of voltage from the constant voltage power source 10 between the electrodes 9, and the value of the electric current running therebetween is detected by the ammeter 11.

The detected current value is input into the calculation section 17. In the calculation section 17, the cell count in the storage section 16 is retrieved on the basis of the input current value, and the corresponding cell count is read out. If there is no accordant current value stored in the storage section 16, the cell count can be obtained by performing an interpolation operation in the calculation section 17. The calculated cell count is output to the display unit 5 and displayed.

It is possible for the operator, by checking the display unit 5, to determine whether or not the count of cells to be transplanted is sufficient, so that he/she can make a quick and right decision to continue or to stop the transplantation.

That is to say, as compared to conventional cases where a part of the concentrated cells has to be taken out and the cell count is microscopically measured, the present invention is advantageous in the point that the cell count can be quickly and accurately checked. Also, another advantage is that there is no need of taking out a part of the concentrated cells as a sample in order to measure the cell count, and thus precious cells can be saved rather than being wasted.

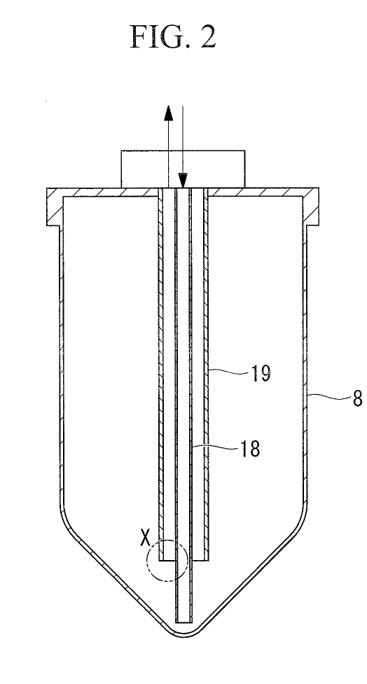

In the cell processing device 1 according to this embodiment, the pair of electrodes 9 are inserted in the concentrated cell suspension A. The method may not only be the method as of FIG. 1 where plate-shaped electrodes 9 are arranged, but also be a method as shown in FIG. 2 where tubes 18 and 19 which form a double-walled tube structure for supplying and discharging the cell suspension A and the digestive fluid are provided in the centrifugal container 8, and at least the distal ends of these tubes 18 and 19 (portion enclosed by the constitute a pair of facing electrodes.

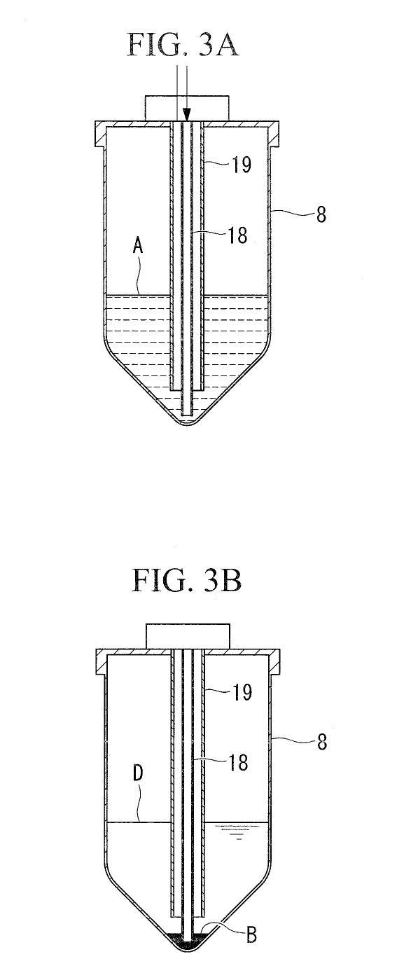

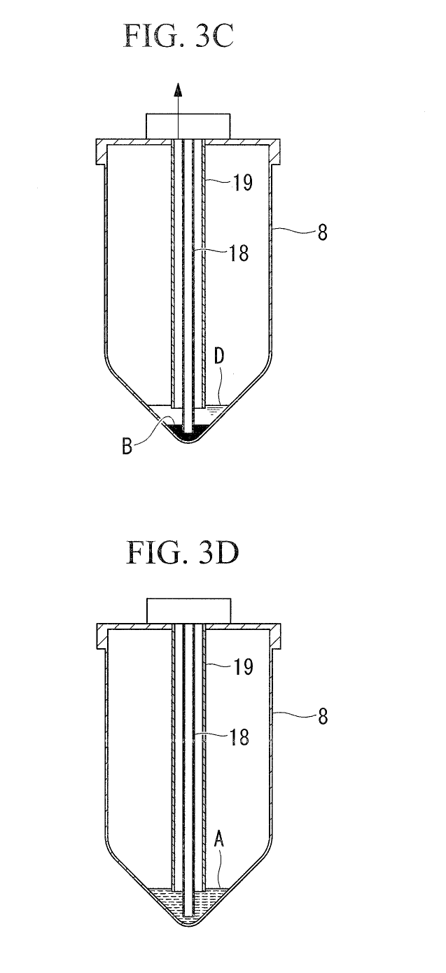

In this case, the cell suspension A supplied through the inner tube 18 into the centrifugal container 8 is subjected to a centrifugal treatment as shown in FIG. 3A, so as to thereby centrifugally separate the cells B and the supernatant D as shown in FIG. 3B, and then the supernatant D is discharged through the outer tube 19 as shown in FIG. 3C. Thereafter, the supply of the washing liquid through the inner tube 18, the centrifugal treatment, and the discharge of the supernatant D, are performed one or more times. By so doing, the concentrated cells B and a remaining part of the supernatant D are given at the bottom as shown in FIG. 3C. Therefore, the concentrated cell suspension A as shown in FIG. 3D can be produced by re-suspending them.

In this state, by applying a voltage between electrodes at the distal ends of the tubes 18 and 19 which are in contact with the cell suspension A, the current value can be detected and the cell count can be calculated.

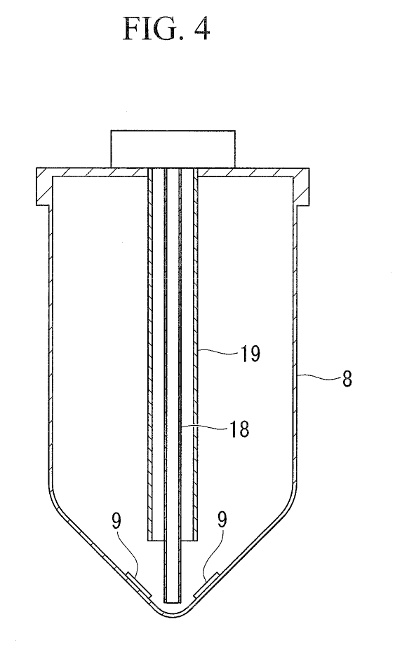

As shown in FIG. 4, the electrodes 9 may be arranged in a pasted state to the inner wall in a vicinity of the bottom of the centrifugal container 8. By so doing, the electrodes 9 can be arranged so as not to hinder the centrifugal treatment.

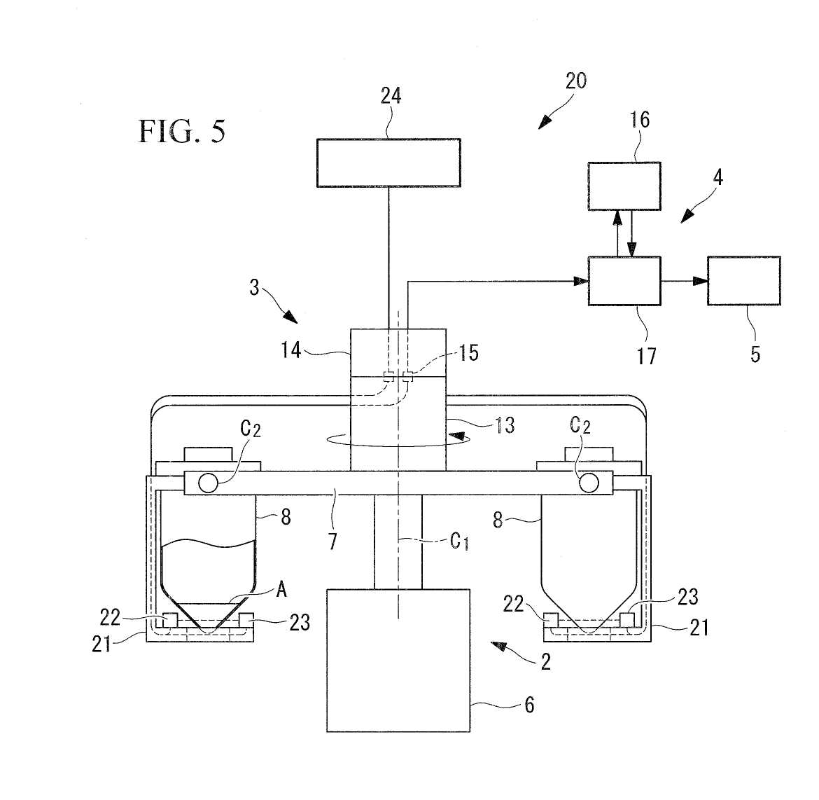

Next is a description of a cell processing device 20 according to a second embodiment of the present invention, with reference to FIG. 5.

In the description of this embodiment, the same reference signs are used for components having common structures with those of the cell processing device 1 according to the first embodiment mentioned above, and the description thereof is omitted.

In this embodiment, the cell count is calculated on the basis of the optical property of the cell suspension A, unlike the cell processing device 1 according to the first embodiment which detects the electrical conduction property of the cell suspension A positioned between the pair of electrodes 9.

Specifically speaking, as shown in FIG. 5, the cell processing device 20 according to this embodiment comprises container holders 21 which detachably hold the centrifugal containers 8 at the distal ends of the arm 7, and a property detection unit 3 comprising light emitters 22 and light receivers 23 is provided on the container holders 21.

The container holder 21 is swingable about the shaft C₂ relative to the arm 7 by the centrifugal force produced when rotating the arm 7.

Accordingly, only by attaching the centrifugal containers 8 to the container holders 21, the centrifugal containers 8 can be swung through the rotation of the arm 7 so as to effect the centrifugal separation of the cell suspension A therein.

In this embodiment, the centrifugal container 8 is made of an optically transparent material. The light emitter 22 and the light receiver 23 are arranged so that the optical axis formed between the light emitter 22 and the light receiver 23 can pass through the cell suspension A within the centrifugal container 8 in a state where the centrifugal container 8 is held on the container holder 21. The light emitter 22 generates a fixed amount of light by a light source controller 24.

The storage section 16 stores the previously measured light reception amount and the cell count by associating them with each other. The turbidity of the cell suspension A is changed depending on the count of cells positioned between the light emitter 22 and the light receiver 23. Therefore, by storing the previously measured light reception amount and the cell count, the cell count can be readily calculated using the detected light reception amount.

According to the thus configured cell processing device 20 of this embodiment, after the production of the concentrated cell suspension A by the centrifugal separator 2, light emitting from the light emitter 22 is transmitted through the cell suspension A and received by the light receiver 23, and thereby the turbidity (optical property) of the cell suspension A can be detected from the light reception amount. Then, the cell count stored in the storage section 16 is retrieved on the basis of the amount of light received by the light receiver 23. If no accordant data of the light reception amount is stored, the cell count can be calculated by performing an interpolation operation.

According to the cell processing device 20 of this embodiment, since the light emitter 22 and the light receiver 23 are provided on the container holder 21 and the centrifugal container 8 is detachably held on the container holder 21, the cell count can be calculated in a non-contact manner without contacting the light emitter 22 and the light receiver 23 to the cell suspension A. As a result, the light emitter 22 and the light receiver 23 can be repeatedly reused by having only the centrifugal container 8 disposable.

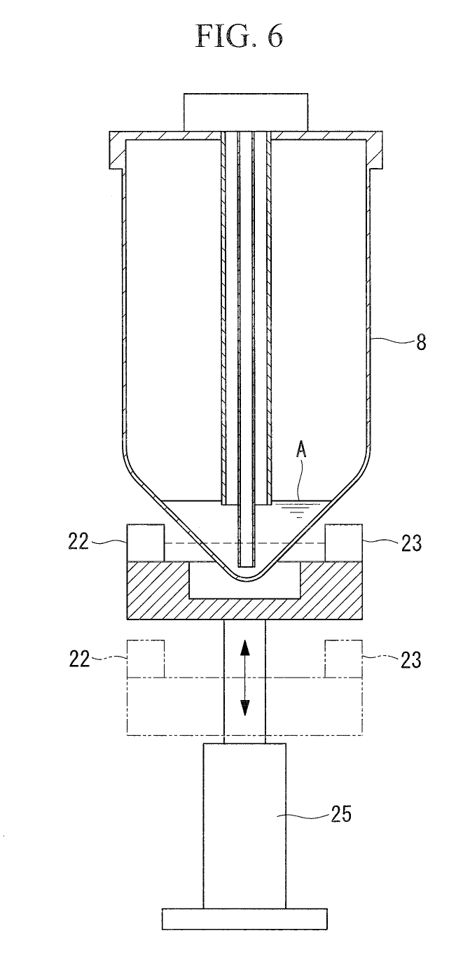

In this embodiment, the light emitter 22 and the light receiver 23 are provided on the container holder 21; however, instead of this, it is also possible, as shown in FIG. 6, to provide a lift mechanism 25 which integrally moves the light emitter 22 and the light receiver 23 upward or downward to the position at which the centrifugal container 8 of the centrifugal separator 2 is stopped. By so doing, at the time of the centrifugal treatment, the light emitter 22 and the light receiver 23 can be lowered to the position indicated by the chain line, by the operation of the lift mechanism 25, so that the light emitter 22 and the light receiver 23 can be withdrawn so as not to interfere with the rotating centrifugal container 8. Also, at the time of measuring the cell count, the light emitter 22 and the light receiver 23 can be raised to the position indicated by the solid line, by the operation of the lift mechanism 25, so that the optical axis between the light emitter 22 and the light receiver 23 can be arranged to transmit through the cell suspension A in the centrifugal container 8. This also makes it possible to measure the cell count in a non-contact manner.

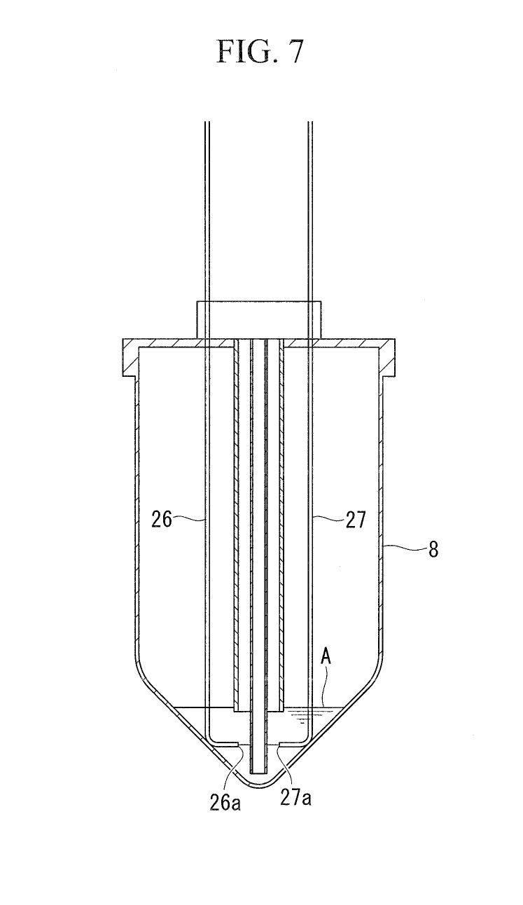

Instead of this, as shown in FIG. 7, end portions 26a and 27a of two optical fibers 26 and 27 may be arranged in the cell suspension A inside the centrifugal container 8, so as to respectively construct the light emitter and the light receiver by using the end portions 26a and 27a of the optical fibers 26 and 27.

What is claimed is:

1. A cell processing device comprising:
a centrifugal separator which concentrates cells by rotating a centrifugal container that contains a cell suspension yielded by digestion of a biological tissue;
a property detection unit which detects a property of the cell suspension contained in the centrifugal container of the centrifugal separator; and
a cell count enumeration unit which calculates the cell count on the basis of the property of the cell suspension detected by the property detection unit.

2. A cell processing device according to claim 1, wherein the property detection unit is a pair of electrodes which are oppositely arranged in the centrifugal container for detecting an electrical conduction property of the cell suspension held therebetween.

3. A cell processing device according to claim 2, wherein the centrifugal container is provided with a double-walled tube which supplies the cell suspension into the centrifugal container and discharges a supernatant therefrom upon the completion of centrifugal separation, and the pair of electrodes are provided on this tube.

4. A cell processing device according to claim 2, wherein the pair of electrodes are provided on an inner wall in a vicinity of the bottom of the centrifugal container.

5. A cell processing device according to claim 1, wherein the property detection unit comprises a light emitter and a light receiver for transmitting light through the cell suspension contained in the centrifugal container so as to thereby detect an optical property of the cell suspension.

6. A cell processing device according to claim 5, wherein the centrifugal container is made of an optically transparent material, and
the light emitter and the light receiver are arranged outside the centrifugal container.

7. A cell processing device according to claim 6, wherein the centrifugal separator comprises a container holder which detachably holds the centrifugal container, and
the light emitter and the light receiver are provided on the container holder.

8. A cell processing device according to claim 6, wherein the device comprises a detection unit transfer mechanism which moves the light emitter and the light receiver closer to or apart from the centrifugal container.
